(19) United States
(12) Patent Application Publication
(10) Pub. No.: US 2011/0167466 A1
(43) Pub. Date: Jul. 7, 2011

(54) Method and Apparatus for Interface to Layer 2 of an Open Systems Interconnection (OSI) Communication Protocol

(75) Inventors: Ali AIOUAZ, Mission Viejo, CA (US); Chris O'BRIEN, San Diego, CA (US)

(73) Assignee: ENTROPIC COMMUNICATIONS, INC., San Diego, CA (US)

(21) Appl. No.: 12/977,778

(22) Filed: Dec. 23, 2010

Related U.S. Application Data
(60) Provisional application No. 61/292,450, filed on Jan. 5, 2010.

(51) Int. Cl. H04N 7/173

(52) U.S. Cl. 725/117

(57) ABSTRACT

A method of communicating with a layer 2 device over any of a plurality of interfaces, including a MoCA network, an Ethernet interface or a serial port. The method includes sending a string of information including a command and an associated address to the layer 2 device over a protocol other than the MoCA protocol via any of the MoCA network. The Ethernet interface or the serial port receives the string within the layer 2 device and executes the command within the layer 2 device based upon the address and the command.

### CROSS-REFERENCE TO RELATED APPLICATIONS

This application claims the benefit of U.S. Provisional Application No. 61/292,450, filed Jan. 5, 2010, which is herein incorporated by reference in its entirety.

### TECHNICAL FIELD

The disclosed method and apparatus relates to communications systems, and more particularly, some embodiments relate to a method and apparatus for interfacing with the data link layer of a seven layer open systems interconnection (OSI) communication protocol stack.

### DESCRIPTION OF THE RELATED ART

Home networks, and home entertainment networks in particular, are becoming more popular. These networks allow communications between various electronic devices in the home, most particularly, home entertainment devices, such as Televisions (TVs), home computers, laptop computers, digital video recorders (DVRs), cable set top boxes, digital video devices (DVDs), audio equipment, etc. In accordance with one architecture for establishing such a network, existing coaxial cabling within the home is used as the communication medium over which communications through the network will take place. In one such architecture, the well-known seven layer Open Systems Interconnection (OSI) reference model is used as the basis for the communication protocol used by the network.

There are multiple configurations possible in the deployments of such networks. One such configuration is shown in FIG. 1. In FIG. 1, both a satellite service provider and a cable television service provider provide content to the network. A satellite antenna 101 (with the associated amplifiers and front end equipment) is coupled to a splitter 103. The splitter 103 provides four taps out to the rest of the network 100. Each of the four taps is coupled to one of four layer 2 (L2) devices 105a, 105b, 105c, 105d. Typically, most of the devices in the home are not initially present and will be added over time. Therefore, the L2 devices will typically have to handle both the presence and the absence of an Ethernet router (with or without Dynamic Host Configuration Protocol (DHCP)). In addition, each L2 device will have to deal with a random startup order of the other network devices (i.e., the L2 device may start up before a DHCP router is ready). Furthermore, there can be an incremental addition of network units connected behind an L2 device 105. The configuration shown in FIG. 1 would likely be deployed by a commercial operator (such as the satellite service provider).

Each of the L2 devices 105 receives packets over the coaxial connection from the satellite antenna 101. These packets are converted to an Ethernet format, output by the L2 devices 105 and distributed to the rest of the network 100.

FIG. 2 illustrates a similar configuration. However, in FIG. 2, an internet cable modem 201 provided by a cable television service provider is coupled to a splitter 203 with four taps that connect to the rest of the network 200. L2 devices 205 are coupled to the taps of the splitter 203 and provide a bridge between the cable modem 201 and the rest of the network 200.

As the network grows and matures, it may become desirable to update the functionality of the L2 devices 105, 205. Therefore, it is desirable to have an efficient way to perform the update of these L2 devices 105, 205. Furthermore, other management communication may be desirable to allow commands to be provided directly to the L2 devices.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates one configuration of a home network.

FIG. 2 illustrates a second configuration of a home network.

FIG. 3 is a simplified block diagram of an L2 device in accordance with one embodiment of the disclosed method and apparatus.

FIG. 4 is an illustration of one image update process in accordance with the disclosed method and apparatus.

FIG. 5 is an illustration of an L2 hostless product.

FIG. 6 and FIG. 7 illustrate virtual pages and addressing in accordance with one embodiment of the disclosed method and apparatus.

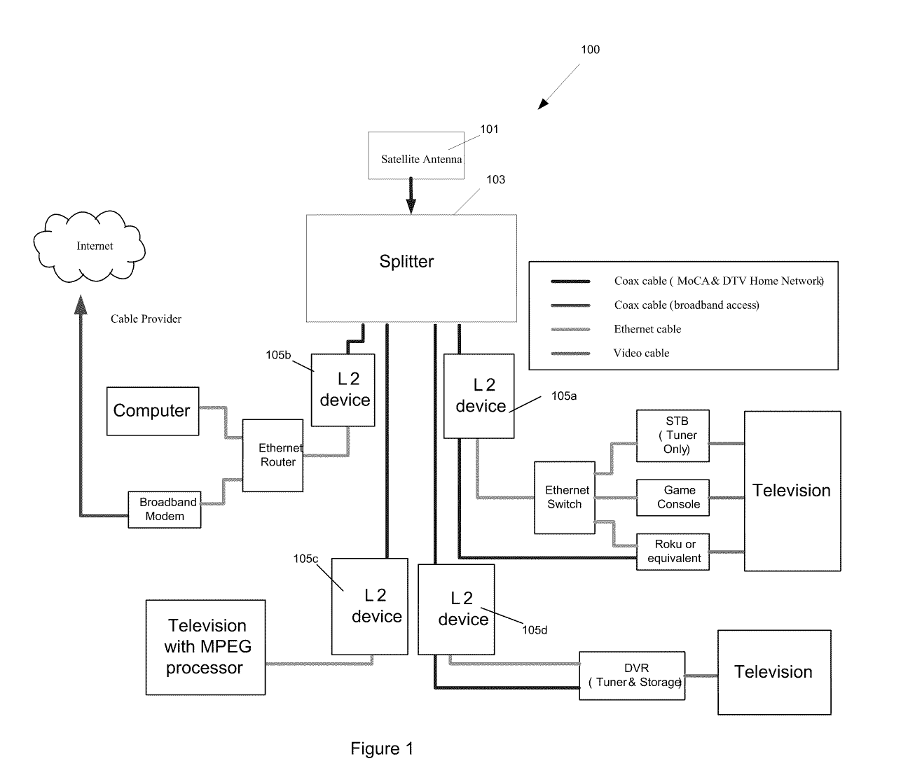

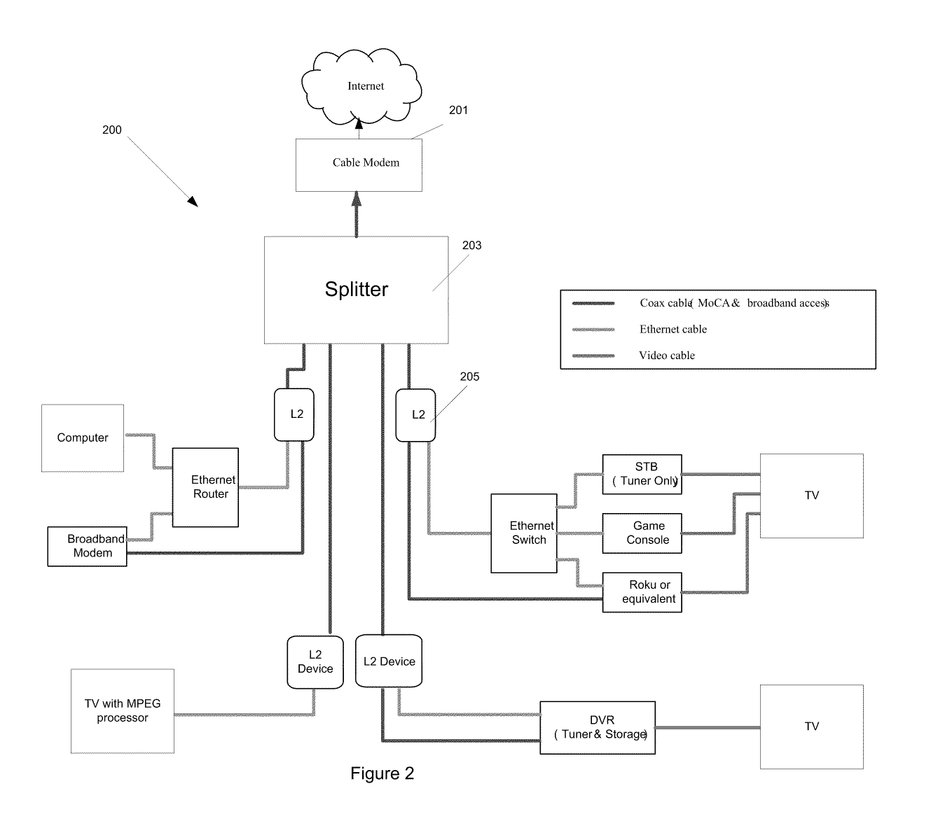

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

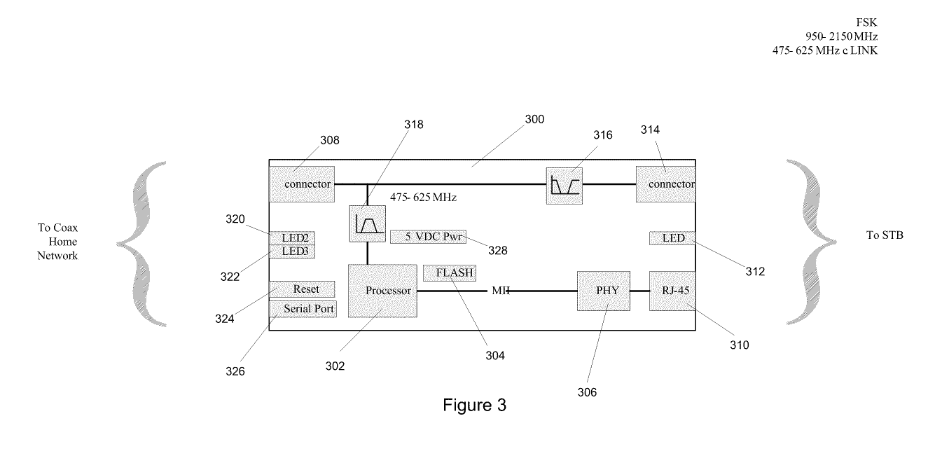

FIG. 3 is a simplified block diagram of a layer 2 (L2) device 300. The L2 device of FIG. 3 includes a processor 302, flash memory 304, physical layer (PHY) device 306, an RJ-45 style connector 310, a power indicating light emitting diode (LED) 312, a first and second RF connector 308, 314, a first and second filter 316, 318, an activity LED 320, a PHY rate LED 322, a reset switch 324, a serial port 326 and a 5 volt DC power supply 328.

In accordance with one embodiment, the software image in the L2 device 300 can be updated over any of three interfaces provided in order to support both operator and retail deployments. The three interfaces include the serial port 326, the Ethernet port or Multi-media over Coax Alliance (MoCA).

In accordance with one embodiment, when the L2 device 300 is purchased by a user directly from a retail store, the user can update the L2 device 300 via any of the interfaces that are populated.

When a MoCA network is already formed and functional, a user can update the L2 device 300 without having to disconnect the L2 device and connect it directly to a personal computer (PC).

During a field image update, the L2 device continues to perform its MoCA operation without degradation to the MoCA performance. The user (operator technician in the operator case or customer in the retail case) may connect to the L2 device 300 and request that the L2 device download a different version of the firmware. The L2 device will download the firmware, verify that the firmware is valid for this type of unit and apply the firmware if so requested by the user. In accordance with one embodiment, applying the firmware will require a restart of the L2 device.

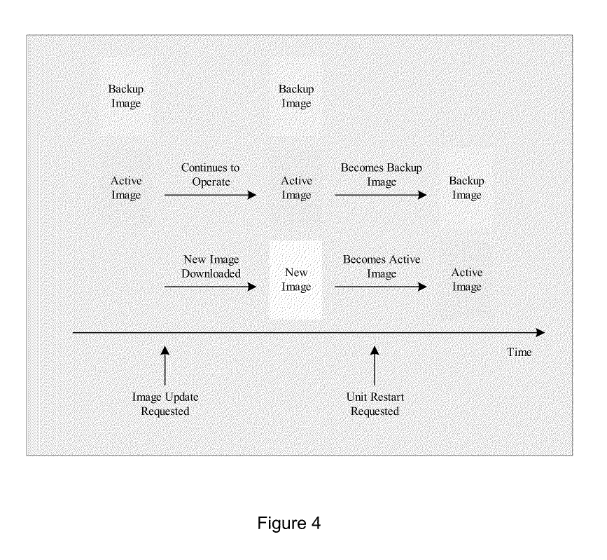

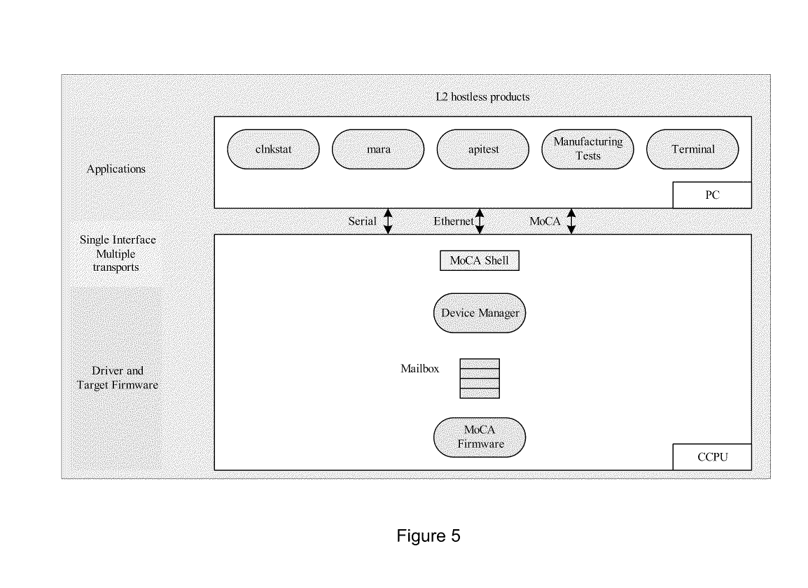

In one embodiment, the update mechanism within the L2 device 300 ensures that there is always one known good image on the device. FIG. 4 is an illustration of one image update process in accordance with the disclosed method and apparatus. The flash layout supports both an active image and a backup image. When an update is performed, the downloaded (new) image shall be validated prior to altering the backup image. Once the downloaded (new) image is validated, on the following restart, the newly downloaded image will become the active image, while the previously active image becomes the backup image as illustrated in FIG. 4.

Due to the constraint in available random access memory (RAM) and due to the need to validate the entire image prior to corrupting the previous image, the field image update mechanism shall rely on a 3rd image area in flash memory 304 to store the new image as it is being downloaded. In one embodiment, across a field image update, the L2 device 300 will maintain the original equipment manufacturer (OEM) customized settings and the customer settings.

In one embodiment of the disclosed method and apparatus, the interface to the L2 device will provide access to controls, configuration and diagnostics. A shell interface is provided consistent with other devices. The purpose of the interface is to ensure interface compatibility across a family of products and so provide an accelerated time to market for multiple partners that need access to control, configuration or diagnostics in MoCA nodes.

Textual binding allows different programming languages to issue commands to the L2 devices without the need to develop or port a programming interface (such as a c.link API) to that particular language (e.g.: JAVA, perl . . . ).

Virtual pages allow functional areas to be separated that are typically developed by separate groups. Pages could also be assigned to OEMs, original device manufacturers (ODMs) or service providers in products when they have the ability to add functionality to the software.

Virtual registers provide a more compact and generic means to interface with the L2 device 300 than can be provided by fully descriptive text. The use of virtual pages also isolates the user from the specifics regarding from where the data is obtained and to where data is written.

The interface is accessible via any of the physical interfaces available on the L2 device 300, including: (1) serial port 326 using an 8N1 data format with a data rate of 115.2 kbps; (2) Ethernet, addressed through IP address and connecting via transmission control protocol (TCP) to a socket; (3) MoCA, addressed through IP address and connecting via TCP to a socket; (4) TCP via a predetermined port number.

The interface is “connection oriented” to allow a client to issue a sequence of commands to the L2 device 300. That is, a client may forget to disconnect from the unit once that client has completed its operation, in accordance with one embodiment of the disclosed method and apparatus. Therefore, upon receiving a connection request from another client, the firmware shall verify that the initial client still needs the interface.

In accordance with one embodiment, relatively little traffic will occur over the interface. Therefore, the interface can be human readable (ASCII). In order for this interface to have a compact embedded implementation and be easily programmed, in accordance with one embodiment, the interface will have the following attributes:

Two types of packets are exchanged: command packets and result code packets.

The interface is synchronous, meaning that a maximum of one command will be in progress at any given time. Additional concurrent commands are not buffered. Therefore, if a second command is received before the initial command completes, an error result code is issued.

The firmware is viewed as a register mapped device with a virtual address map using “big endian” addressing in which low order bytes are stored in the higher order addresses and high order bytes are stored in lower order address. It will be understood by those skilled in the art that in an alternative embodiment, any other addressing scheme can be used. The virtual map concept in accordance with one embodiment is described in more detail below. Each register is 32 bits in length when it comes to the address map, but allows virtually mapping larger areas to that address. For instance, a register may be the address to access a software buffer. Reading N bytes from that buffer will return the N first bytes within that buffer.

Within each packet, white spaces are used as delimiters (single white space is a delimiter; successive white spaces not allowed) for command and parameters. A carriage return indicates the end of the packet. Line feeds are ignored.

In accordance with one embodiment, non-ASCII characters generate an error response on the next carriage return received. Specifically, in one particular embodiment, the backspace character is not supported.

A prompt “>” is provided upon connect and each time the L2 device 300 is ready for the next command (upon receiving an empty line with a carriage return; or after returning data in a synchronous response; or after sending data in an asynchronous notification).

In one embodiment, the interface is case sensitive and expects lower case.

In one embodiment, the interface does not provide an echo. If the user uses wishes to view the commands sent, the use can enable a local echo on the terminal used.

The general command format and corresponding result code are as follows:

> cmd <param1> <param2><CR>
<data1><CR>
. . .
<RESULT CODE><CR>
<CR>
>

Whereby:

>: prompt provided by the shell interface;
cmd: is issued by the user and is one of the supported commands
listed in Table 1
<param1>: first parameter for the associated cmd
<param2>: second parameter for the associated cmd when
applicable; note that this parameter may include spaces
<data1>: first data element returned by the shell interface when
applicable
. . . : denotes further optional data elements returned by the shell
interface when applicable
<result code>: indicates whether the command was successful
(result code: ok) or not (result code: error)
<CR>: carriage return

The following is an example of a read command (see Table 1 below) in which 8 bytes are to be read from an address 0x1000 where the firmware has a buffer mapped at that virtual address with a content of 0x12 0x34 0x56 0x78 0x90 0xab 0xcd 0xef when listed from byte 0 to byte 7 in incremental byte addresses. It should be noted that for the purposes of this disclosure, the hexidecimal value “1A” is written as “0x1a”, where the prefix “0x” indicates that the value is shown in hexidecimal format:

(Carriage returns are omitted below to only show screen output)

> read 0x1000 8
0x1000-0 0x12345678
0x1000-1 0x90abcdef
ok
>

The following is an example for a write command (see Table 1 below) in which 6 bytes (0x11 0x22 0x33 0x44 0x55 0x66) are to be written to the same buffer followed by a read of 8 bytes:

> write 0x1000 0x1122 0x3344 0x5566
ok
> read 0x00001000 8
0x1000-0 0x11223344
0x1000-1 0x5566cdef
ok
>

TABLE 1
Synchronous Commands
Commands (synchronous)

| read <address> <length> | | Requests the read of <length> bytes mapped at a virtual register <address>. |
|---|---|---|
| | | Reading more than 4 bytes is only valid for registers that are mapped to |
| | | data larger than 4 byte; it does not read the next register (user needs to use |
| | | readvreg if he desires to read multiple registers). |
| | Address | Address in hex format of the virtual register where the read is requested to |
| | | be performed. Address is up to 64 bits. The address may be truncated (ex: |
| | | 0xab or 0x0ab). |
| | Length | Number of virtual bytes to be read and returned. Parameter may be omitted, |
| | | in which case the interface returns all available and valid data mapped at |
| | | the corresponding register. Minimum size return is 32 bits. Any length not |
| | | multiple of 32 bits is rounded up to the next 4 bytes when executed by the |
| | | shell. |
| Result code | address-x data | As a user may request more than 4 bytes from a virtual address using the |
| | ok/error | read command, the shell will return the data using as many entries as |
| | | necessary to account for all data requested. The format for each 32 bits |
| | | entry returned is: |
| | | address-x data |
| | | For instance if 12 bytes are read from address 0x1000 |
| | | 0x1000-0 0x11223344 |
| | | 0x1000-1 0x55667788 |
| | | 0x1000-2 0xaabbccdd |
| | | When successful, the returned entries are followed by ‘ok’. When |
| | | unsuccessful, no entry is returned and ‘error’ is the result code. |
| readvreg <address> <length> | | Requests the read of <length> consecutive bytes in the virtual register map, |
| | | starting at <address>. |
| | Address | Address in hex format of the virtual register where to start the read. |
| | | Address is up to 64 bits. The address may be truncated (ex: 0xab or 0x0ab). |
| | length | Number of consecutive virtual registers to read starting at the virtual |
| | | address. Parameter may be omitted in which case only the addressed virtual |
| | | register is returned. |
| Result code | address data | The shell returns as many 32 bits virtual registers as requested by reading |
| | ok/error | linearly the virtual register map. The format for each 32 bits virtual register |
| | | entry returned is: |
| | | address data |
| | | For instance if 4 virtual registers are read from address 0x1000 |
| | | 0x1000 0x12345678 |
| | | 0x1001 0x0102beef |
| | | 0x1002 0xcafe9988 |
| | | 0x1003 0x00001244 |
| | | When successful, the returned entries are followed by ‘ok’. When |
| | | unsuccessful, no entry is returned and ‘error’ is the result code. |
| | | If a particular register maps to more than four virtual bytes, only the first |
| | | four bytes are returned for that register. |
| write <address> <data> | | Writes <data> to the register mapped at <address>. |
| | Address | Address in hex format of the virtual register where to perform the write. |
| | Data | Data to be written. Data may be multiple of 8 bits, 16 bits or 32 bits (these |
| | | are exclusive and each 8/16/32 element shall be separate with a white |
| | | space). It may be provided in hexadecimal or decimal format. To provide |
| | | hexadecimal values, prepend the value with “0x”. Data shall be provided |
| | | MSB first (or most significant 16 bits or most significant 32 bits). |
| Result code | ok/error | When successful, the result code is ‘ok’. When unsuccessful, ‘error’ is the |
| | | result code. No data is ever returned via this command. |
| writevreg <address> <data> | | Requests the write of <data> to consecutive registers. Data is written |
| | | consecutively to as many registers as necessary to exhaust the data |
| | | provided. |
| | | For instance if the register mapped by <address> has a size of one byte and |
| | | if three bytes are provided, then only the first byte of data is written at the |
| | | register pointed to by <address> and the remaining <data> is written to the |
| | | following register(s). |
| | Address | Address in hex format of the virtual register where to start the write. |
| | Data | Data to be written. Data may be multiple of 8 bits, 16 bits or 32 bits (these |
| | | are exclusive and each 8/16/32 element shall be separate with a white |
| | | space). It may be provided in hexadecimal or decimal format. To provide |
| | | hexadecimal values, prepend the value with “0x”. Data shall be provided |
| | | MSB first (or most significant 16 bits or most significant 32 bits). |
| Result code | ok/error | When successful, the result code is ‘ok’. When unsuccessful, ‘error’ is the |
| | | result code. No data is ever returned via this command. |
| page <pageid> | | Selects the virtual page to be accessed for the following commands. |
| | Pageid | Virtual page selected: |
| | | 0: MoCA Firmware virtual page (all MoCA specific controls, configuration |
| | | or diagnostics) |
| | | 1: MoCA host functionality (all host functionalities specific controls, |
| | | configuration or diagnostics) |
| | | 100: Chip registers virtual page (effectively provides direct access to chip) |
| Result code | ok/error | When successful, the result code is ‘ok’. When unsuccessful, ‘error’ is the |
| | | result code. No data is ever returned via this command. |

The use of virtual registers allows all exposed configuration parameters, controls and diagnostics to be accessible via memory addressing. The memory addressing has multiple overlaid pages, each of which allow full 64 bits addressing. The use of pages allow different groups and/or functional areas to expand their virtual register set without the need to negotiate addresses with other groups and/or functional areas. The same address may have different meaning depending on the page accessed.

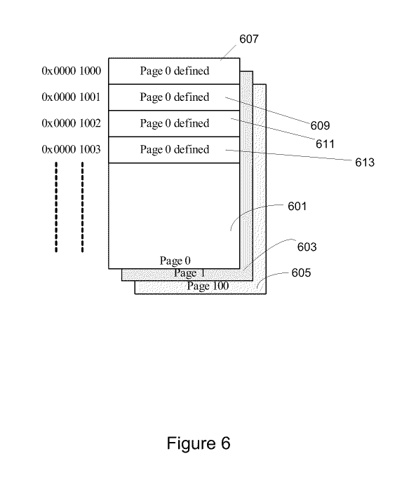

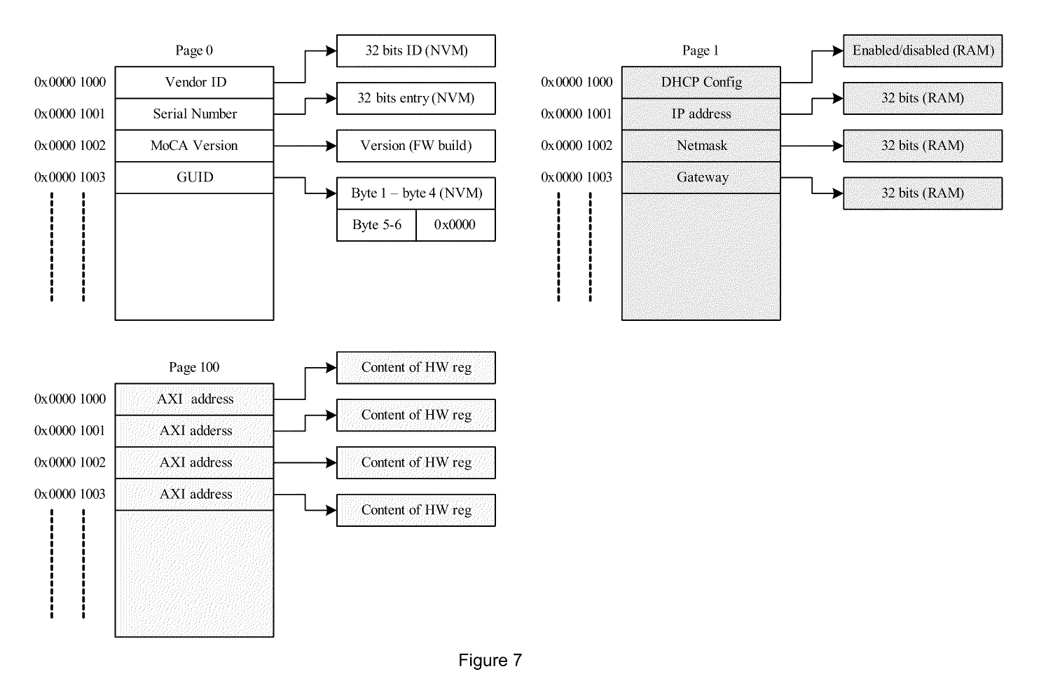

FIG. 6 and FIG. 7 illustrate virtual pages and addressing in accordance with one embodiment of the disclosed method and apparatus. Arbitrary values/names were selected for illustrative purposes.

Each page 601, 603, 605 has a number of registers 607, 609, 611, 613. Each register 607, 609, 611, 613 provides access to a particular function or data. In one embodiment, each may point to more than 32 bits of data.

The user of the shell API does not need to know where the data is physically located (NVM, RAM, image itself). Because the same shell structure can be used by various devices, the user maintains a consistent access method across L2 hosted, L2 hostless and Layer 3 (L3) products. In one embodiment, there are no user levels. Any user may execute any shell command. The lack of user levels makes the interface as simple as possible. In one embodiment, no programming interface (e.g. C/C++ library) is provided. A device API, such as the “clink API” may be ported to access the shell.

As an IP network citizen, the L2 device can: use an IP address assigned via DHCP, statically or through LLA; consume IP packets that are targeted to that IP address; be discovered on the network; and limit the required footprint.

The L2 hostless dongle may have its IP address configuration in one of three ways:

Statically through the shell: the user may assign a static IP address and configuration.

Dynamically through DHCP: (default) the user may set the unit to request its

IP address from a DHCP server on the network.

Dynamically through LLA: when configured for DHCP, if the DHCP server does not provide an IP address within one minute (no DHCP server present on the network or DHCP server being down), the unit shall still obtain an IP address automatically; to that end it shall negotiate via LLA with other devices on the network. When the unit obtains an LLA negotiated IP address, the unit shall continue to attempt to obtain a DHCP IP address (5 minutes interval) and if a DHCP lease is obtained, the unit shall switch back to DHCP and drop any on-going connection to that unit.

Note that any broadcast to obtain an IP address (DHCP, LLA) shall occur on both network interfaces (Ethernet and MoCA) as the remote devices may be located on either of these network interfaces.

Regarding consuming IP packets, in accordance with one embodiment, the L2 device will be addressable by machines located either on the Ethernet end or on the MoCA end of its interfaces. This implies the CCPU firmware and TCs firmware shall be modified to route locally IP frames that are targeted to its Ethernet MAC. In addition, the firmware will be modified to duplicate broadcast IP frames for local consumption and pass-through to the other network interface.

While various embodiments of the disclosed method and apparatus have been described above, it should be understood that they have been presented by way of example only, and should not limit the claimed invention. Likewise, the various diagrams may depict an example architectural or other configuration for the disclosed method and apparatus. This is done to aid in understanding the features and functionality that can be included in the disclosed method and apparatus. The claimed invention is not restricted to the illustrated example architectures or configurations, rather the desired features can be implemented using a variety of alternative architectures and configurations. Indeed, it will be apparent to one of skill in the art how alternative functional, logical or physical partitioning and configurations can be implemented to implement the desired features of the disclosed method and apparatus. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed method and apparatus is described above in terms of various exemplary embodiments and implementations, it should be understood that the various features, aspects and functionality described in one or more of the individual embodiments are not limited in their applicability to the particular embodiment with which they are described. Thus, the breadth and scope of the claimed invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of communicating with a layer 2 device over any of a plurality of interfaces, including a MoCA network, an Ethernet interface or a serial port comprising:
a) sending a string of information including a command and an associated address to the layer 2 device over a protocol other than the MoCA protocol via any of the MoCA network, the Ethernet interface or the serial port;
b) receiving the string within the layer 2 device; and
c) executing the command within the layer 2 device based upon the address and the command.

2. The method of claim 1, wherein memory and software can be controlled by a received command using a virtual address.

3. The method of claim 2, wherein a user can define new sets of virtual registers, allowing them to customize the layer 2 device.
